(19) United States
(12) Patent Application Publication
(10) Pub. No.: US 2025/0016739 A1
(43) Pub. Date: Jan. 9, 2025

(54) DEMAND PAGING

(71) Applicant: Samsung Electronics Co., Ltd., Suwon-si (KR)

(72) Inventors: Anil Agiwal, Allen, TX (US); Shiyang Leng, Allen, TX (US); Kyeongin Jeong, Allen, TX (US)

(21) Appl. No.: 18/741,614

(22) Filed: Jun. 12, 2024

Related U.S. Application Data
(60) Provisional application No. 63/524,769, filed on Jul. 3, 2023.

(51) Int. Cl. H04W 68/02; H04W 52/02

(52) U.S. Cl. CPC H04W 68/02; H04W 52/02

(57) ABSTRACT

A user equipment (UE) includes a transceiver configured to receive, from a base station (BS), a signal. The UE further includes a processor operably coupled to the transceiver. The processor is configured to generate, based on the received signal, a paging request. The transceiver is further configured to transmit the paging request, and receive, based on the paging request, a paging.

### CROSS-REFERENCE TO RELATED APPLICATION(S) AND CLAIM OF PRIORITY

This application claims priority under 35 U.S.C. § 119(e) to U.S. Provisional Patent Application No. 63/524,769 filed on Jul. 3, 2023. The above-identified provisional patent application is hereby incorporated by reference in its entirety.

### TECHNICAL FIELD

This disclosure relates generally to wireless networks. More specifically, this disclosure relates to methods and apparatuses for on demand paging.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides methods and apparatuses for on demand paging.

In one embodiment, a user equipment (UE) is provided. The UE includes a transceiver configured to receive, from a base station (BS), a signal. The UE further includes a processor operably coupled to the transceiver. The processor is configured to generate, based on the received signal, a paging request. The transceiver is further configured to transmit the paging request, and receive, based on the paging request, a paging.

In another embodiment, a BS is provided. The BS includes a processor, and a transceiver operatively coupled to the process. The transceiver is configured to transmit a signal, and receive, from a UE, a paging request. The transceiver is further configured to transmit, based on the paging request, a paging.

In yet another embodiment, a method of operating a UE is provided. The method includes receiving, from a BS, a signal, and generating, based on the received signal, a paging request. The method further includes transmitting the paging request, and receiving, based on the paging request, a paging.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIGS. 4A-4B illustrate a method for on demand paging according to embodiments of the present disclosure;

FIG. 5 illustrates another method for on demand paging according to embodiments of the present disclosure;

FIG. 6 illustrates another method for on demand paging according to embodiments of the present disclosure;

FIG. 7 illustrates another method for on demand paging according to embodiments of the present disclosure; and

FIG. 8 illustrates another method for on demand paging according to embodiments of the present disclosure.

### DETAILED DESCRIPTION

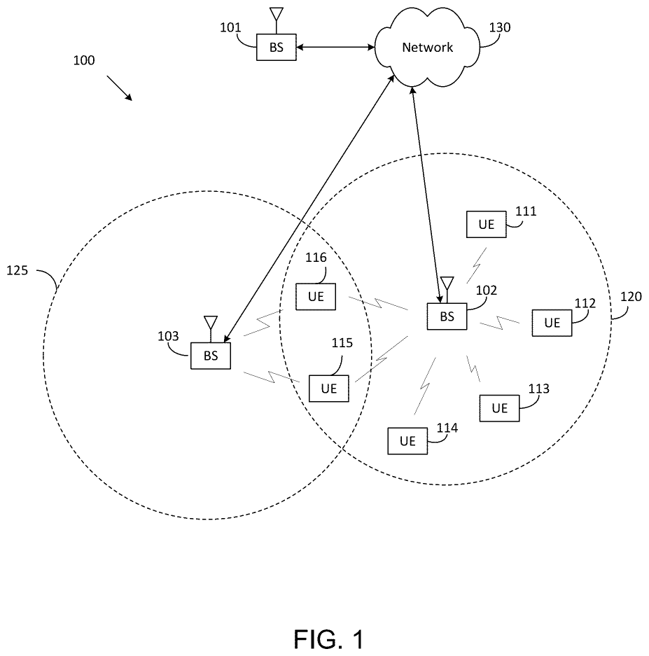

FIGS. 1 through 8, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the LUE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for on demand paging. In certain embodiments, one or more of the gNBs 101-103 includes circuitry, programing, or a combination thereof, to support on demand paging in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

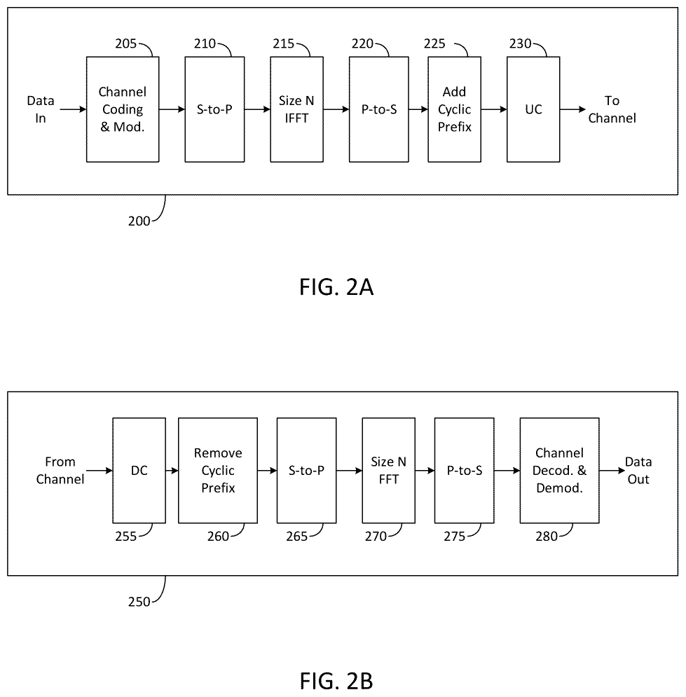

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support on demand paging as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

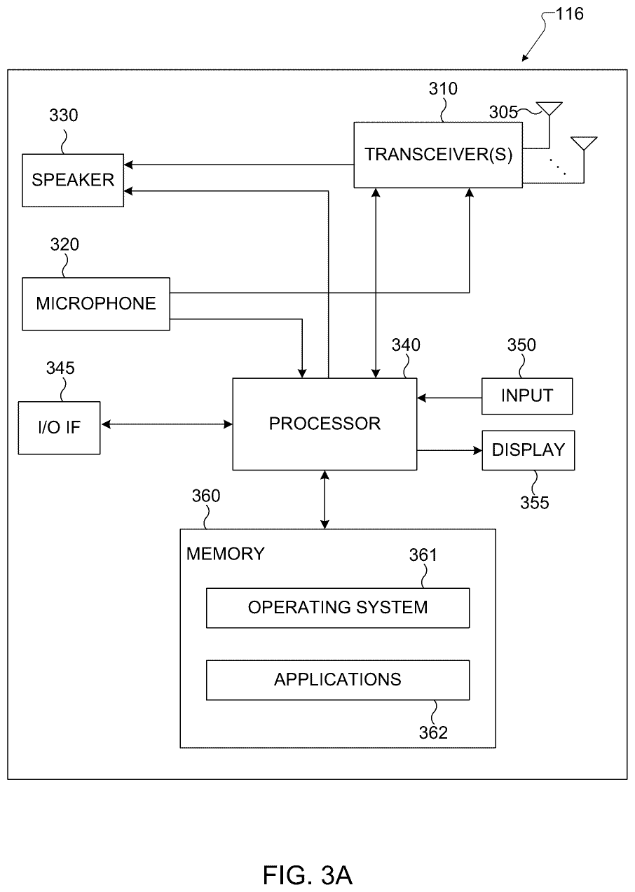

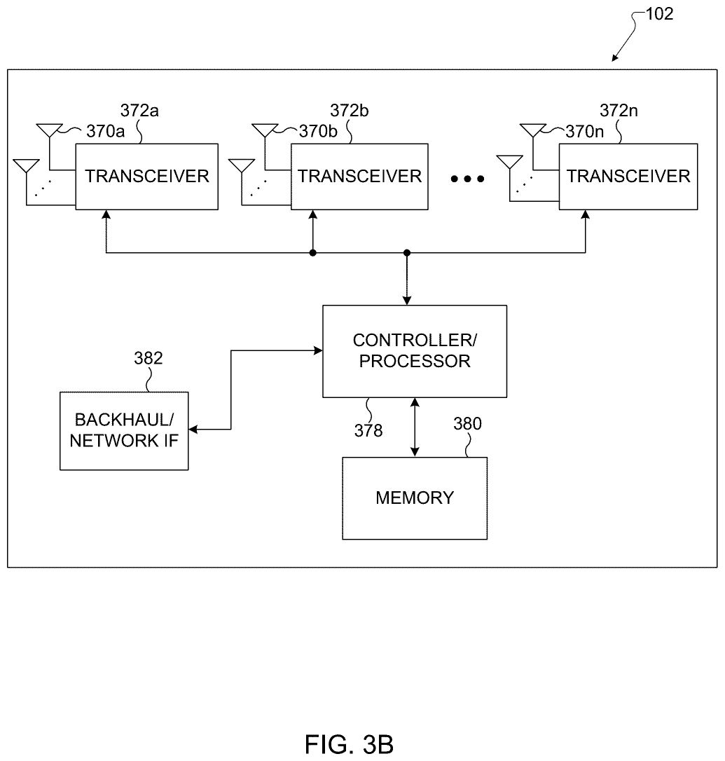

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the ULE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for on demand paging as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support on demand paging as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G (B5G), 6G) supports not only lower frequency bands but also higher frequency (mmWave, tera hertz) bands (e.g., 10 GHz to 100 GHz bands), so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large-scale antenna techniques are being considered in the design of the fifth-generation wireless communication system. In addition, the nextgeneration wireless communication system is expected to address different use cases having quite different requirements in terms of data rate, latency, reliability, mobility etc. However, it is expected that the design of the air-interface of the next-generation wireless communication system would be flexible enough to serve UEs having quite different capabilities depending on the use case and market segment the UE caters to service the end customer. A few example use cases the next-generation wireless communication system wireless system is expected to address are enhanced Mobile Broadband (eMBB), massive Machine Type Communication (m-MTC), ultra-reliable low latency communication (URLL) etc. The eMBB requirements like tens of Gbps data rate, low latency, high mobility, etc., address the market segment representing the conventional wireless broadband subscribers needing internet connectivity everywhere, all the time and on the go. The m-MTC requirements like very high connection density, infrequent data transmission, very long battery life, low mobility, etc., address the market segment representing the Internet of Things (IoT)/Internet of Everything (IoE) envisioning connectivity of billions of devices. The URLL requirements like very low latency, very high reliability, variable mobility, etc., address the market segment representing Industrial automation applications, vehicle-to-vehicle/vehicle-to-infrastructure communication (foreseen as one of the enablers for autonomous cars), etc.

In the next generation wireless communication system (e.g., 5G, beyond 5G (B5G), 6G) operating in higher frequency (mmWave) bands, the UE and gNB communicate with each other using beamforming. Beamforming techniques are used to mitigate propagation path losses and to increase the propagation distance for communication at the higher frequency band. Beamforming enhances the transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred as a transmit (TX) beam. A wireless communication system operating at high frequency uses a plurality of narrow TX beams to transmit signals in the cell, as each narrow TX beam provides coverage to a part of cell. The narrower the TX beam, the higher the antenna gain and hence the higher the propagation distance of a signal transmitted using beamforming. A receiver can also generate a plurality of receive (RX) beam patterns of different directions. Each of these receive patterns can be also referred as a receive (RX) beam.

The next generation wireless communication system supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with CA/DC there is only one serving cell comprising the primary cell. For a UE in an RRC_CONNECTED state configured with CA/DC the term ‘serving cells’ is used to denote the set of cells comprising the Special Cell(s) and all secondary cells. In NR the term Master Cell Group (MCG) refers to a group of serving cells associated with the Master Node, comprising the PCell and optionally one or more SCells. In NR the term Secondary Cell Group (SCG) refers to a group of serving cells associated with the Secondary Node, comprising the PSCell and optionally one or more SCells. In NR the term PCell (primary cell) refers to a serving cell in a MCG, operating on the primary frequency, in which the UE either performs the initial connection establishment procedure or initiates the connection re-establishment procedure. In NR for a UE configured with CA, a Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation the term SpCell (i.e., Special Cell) refers to the PCell of the MCG or the PSCell of the SCG, otherwise the term Special Cell refers to the PCell.

In the next generation wireless communication system, a node B (gNB) or base station in cell broadcast Synchronization Signal and PBCH block, also referred to as a Synchronization Signal Block (SSB), comprises primary and secondary synchronization signals (PSS, SSS) and system information. System information includes common parameters needed to communicate in a cell. In the next generation wireless communication system (also referred as next generation radio or NR), System Information (SI) is divided into the MIB and a number of SIBs where: The MIB is transmitted on the BCH with a periodicity of 80 ms and repetitions made within 80 ms and it includes parameters that are needed to acquire SIB1 from the cell. The SIB1 is transmitted on the DL-SCH with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to an SI message, periodicity, SI-window size) of other SIBs with an indication whether one or more SIBs are only provided on-demand, and, in that case, the configuration needed by the UE to perform the SI request. SIB1 is a cell-specific SIB; SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as SI area, which comprises one or several cells and is identified by systemInformationAreaID. The mapping of SIBs to SI messages is configured in schedulinglnfoList, while the mapping of posSIBs to SI messages is configured in pos-SchedulinglnfoList. Each SIB is contained only in a single SI message and each SIB and posSIB is contained at most once in that SI message. For a UE in an RRC_CONNECTED state, the network can provide system information through dedicated signaling using the RRCReconfiguration message, e.g., if the UE has an active BWP with no common search space configured to monitor system information, paging, or upon request from the UE. In the RRC_CONNECTED state, the UE acquires the required SIB(s) from the PCell. For a PSCell and SCells, the network provides the required SI by dedicated signaling, i.e., within an RRCReconfiguration message. Nevertheless, the UE acquires the MIB of the PSCell to get SFN timing of the SCG (which may be different from MCG). Upon change of relevant SI for the SCell, the network releases and adds the concerned SCell. For PSCell, the required SI can only be changed with Reconfiguration with Sync.

In the next wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by a non-synchronized UE in an RRC CONNECTED state. Several types of random-access procedures are supported such as contention based random access, contention free random access and each of these can be one of 2 step or 4 step random access.

In the next generation wireless communication system, a Physical Downlink Control Channel (PDCCH) is used to schedule DL transmissions on PDSCH and UL transmissions on PUSCH, where the Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for PUCCH and PUSCH; transmission of one or more TPC commands for SRS transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

In the next generation wireless communication system (e.g., 5G), a list of search space configurations is signaled by a gNB for each configured BWP of a serving cell, wherein each search configuration is uniquely identified by a search space identifier. The search space identifier is unique amongst the BWPs of a serving cell. An identifier of a search space configuration to be used for a specific purpose such as paging reception, SI reception, random access response reception is explicitly signaled by the gNB for each configured BWP. In NR, the search space configuration comprises parameters Monitoring-periodicity-PDCCH-slot, Monitoring-offset-PDCCH-slot, Monitoring-symbols-PDCCH-within-slot, and duration. A UE determines PDCCH monitoring occasion (s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

(y*(number of slots in a radio frame)+x−Monitoring-offset-PDCCH-slot)mod(Monitoring-periodicity-PDCCH-slot)=0;

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with the search space configuration. A list of CORESET configurations are signaled by the gNB for each configured BWP of a serving cell, wherein each CORESET configuration is uniquely identified by a CORESET identifier. The CORESET identifier is unique amongst the BWPs of a serving cell. Note that each radio frame is of 10 ms duration. Each radio frame is identified by a radio frame number or system frame number. Each radio frame comprises several slots, wherein the number of slots in a radio frame and duration of slots depends on sub carrier spacing. The number of slots in a radio frame and duration of slots for each supported SCS is pre-defined in NR. Each CORESET configuration is associated with a list of TCI (Transmission configuration indicator) states. One DL RS ID (SSB or CSI RS) is configured per TCI state. The list of TCI states corresponding to a CORESET configuration is signaled by the gNB via RRC signaling. One of the TCI states in a TCI state list is activated and indicated to the UE by the gNB. The TCI state indicates the DL TX beam (DL TX beam is QCLed with SSB/CSI RS of TCI state) used by the gNB for transmission of a PDCCH in the PDCCH monitoring occasions of a search space.

In the next generation wireless communication system bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring a RRC connected UE with BWP(s) and telling the UE which of the configured BWPs is currently the active one. When BA is configured, the UE only monitors PDCCH on the one active BWP i.e., it does not monitor PDCCH on the entire DL frequency of the serving cell. In an RRC connected state, the UE is configured with one or more DL and UL BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a particular time. BWP switching is controlled by the PDCCH indicating a downlink assignment or an uplink grant, by the bwp-InactivityTimer, by RRC signaling, or by the MAC entity itself upon initiation of a Random-Access procedure. Upon addition of an SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

In the next generation (e.g. 5^{th} generation NR or New Radio) wireless communication system, the UE can be in one of the following RRC states: RRC IDLE, RRC INACTIVE and RRC CONNECTED. The RRC states can further be characterized as follows:
In the RRC_IDLE state, a UE specific DRX may be configured by upper layers (i.e., NAS). The UE monitors Short Messages transmitted with P-RNTI over DCI; monitors a Paging channel for CN paging using 5G-S-TMSI; performs neighbouring cell measurements and cell (re-)selection; and acquires system information and can send SI requests (if configured).
In the RRC_INACTIVE state, a UE specific DRX may be configured by upper layers or by the RRC layer; In this state, the UE stores the UE Inactive AS context. A RAN-based notification area is configured by the RRC layer. The UE monitors Short Messages transmitted with P-RNTI over DCI; monitors a paging channel for CN paging using 5G-S-TMSI and RAN paging using full I-RNTI; performs neighbouring cell measurements and cell (re-)selection; performs RAN-based notification area updates periodically and when moving outside the configured RAN-based notification area; and acquires system information and can send SI requests (if configured).
In the RRC_CONNECTED state, the UE stores the AS context. Unicast data is transmitted/received to/from the UE. At lower layers, the UE may be configured with a UE specific DRX. The UE monitors Short Messages transmitted with P-RNTI over DCI, if configured; monitors control channels associated with the shared data channel to determine if data is scheduled for it; provides channel quality and feedback information; performs neighbouring cell measurements and measurement reporting; and acquires system information.

Paging allows the network to reach UEs in an RRC_IDLE and in an RRC_INACTIVE state through paging messages, and to notify UEs in RRC_IDLE, RRC_INACTIVE and RRC_CONNECTED states of system information change and ETWS (Earthquake and Tsunami Warning System)/CMAS (Commercial Mobile Alert System) indications through short messages. Both paging messages and short messages are addressed with P-RNTI on PDCCH, but while the former is sent on a PCCH logical channel (transport block [TB] carrying paging message is transmitted over PDSCH (Physical downlink shared channel)), the latter is sent over a PDCCH directly.

While in an RRC_IDLE state the UE monitors the paging channels for CN-initiated paging. While in an RRC_INACTIVE state the UE monitors paging channels for RAN-initiated paging and CN-initiated paging. A UE need not monitor paging channels continuously though. Paging DRX is defined where the UE in an RRC_IDLE or RRC_INACTIVE state is only required to monitor paging channels during one Paging Occasion (PO) per DRX cycle. The Paging DRX cycles are configured by the network:
1) For CN-initiated paging, a default cycle is broadcast in system information;
2) For CN-initiated paging, a UE specific cycle can be configured via NAS signaling;
3) For RAN-initiated paging, a UE-specific cycle is configured via RRC signaling;
   The UE uses the shortest of the DRX cycles applicable i.e., a UE in an RRC_IDLE state uses the shortest of the first two cycles above, while a UE in an RRC_INACTIVE state uses the shortest of the three.

The POs of a UE for CN-initiated and RAN-initiated paging are based on the same UE ID, resulting in overlapping POs for both. The number of different POs in a DRX cycle is configurable via system information and a network may distribute UEs to those POs based on the UEs' IDs.

In order to reduce UE power consumption due to false paging alarms, the group of UEs monitoring the same PO can be further divided into multiple subgroups. With subgrouping, a UE shall monitor PDCCH in its PO for paging if the subgroup to which the UE belongs is paged as indicated via an associated PEI (Paging Early Indication). If a UE cannot find its subgroup ID with the PEI configurations in a cell or if the UE is unable to monitor the associated PEI occasion corresponding to its PO, it shall monitor the paging in its PO.

Currently, UEs periodically wake up once per DRX cycle, which dominates the power consumption in periods with no signaling or data traffic. If UEs are able to wake up only when they are triggered, e.g., during paging, power consumption could be dramatically reduced. This can be achieved by using a wake-up signal to trigger the main radio (MR) and a separate low power wakeup receiver (LR) which has the ability to monitor the wake-up signal with ultra-low power consumption. The main radio works for data transmission and reception, which can be turned off or set to deep sleep unless it is turned on. A low power wakeup receiver and wakeup signal design is being studied to minimize UE power consumption. The low power wakeup receiver (LR) is expected to consume 1/100 of the power consumed by the MR. It is expected that a UE in an RRC_IDLE or RRC_INACTIVE state shall monitor the low power wakeup signal (LP WUS) using the LR if the UE and camped cell supports LP WUS. The gNB transmits the low power wakeup signal when the gNB needs to send RAN paging or CN paging to the UE or SI/emergency notifications to the UE. If the LP WUS is received (or LP WUS for UE/UE specific paging subgroup is received), the UE monitors PEI (using MR) and/or subsequently the UE monitors PO (using MR) and receives a paging message if a PEI indicates paging for the UE/UE specific paging subgroup (or a bit in the PEI corresponding to UE's paging subgroup is set to 1 or in case there are no paging subgroups supported in cell, there is one bit common for all UEs in the PEI and the bit is set to 1).

In the existing design, upon transmitting LP WUS, the gNB transmits a PDCCH addressed to a P-RNTI in PEI occasions, the gNB transmits a PDCCH addressed to a P-RNTI in PO and a paging message in PDSCH. A PDCCH addressed to the P-RNTI is transmitted in ‘N*X’ PDCCH monitoring occasions in PO and PEI, where N is the number of transmitted SSBs in the cell and X is the number of repetitions per SSB. In case of beamforming, an SSB is transmitted using a transmission beam which covers a part of cell. A transport block (TB) including the paging message is also transmitted ‘N*X’ times on the PDSCH. The PDCCH and PDSCH are transmitted ‘N*X’ times because the cell transmitting the PDCCH and PDSCH is not aware of the location of UEs to be paged in the cell. In the RRC_IDLE and RRC_INACTIVE state, the network is also not aware of the cell in which UE is located, and these ‘N*X’ transmissions of PDCCH and PDSCH for paging are repeated in multiple cells (e.g., in cells of a registration area or RAN notification area). This leads to significant overhead and increased network energy consumption. The present disclosure provides solutions to overcome these issues.

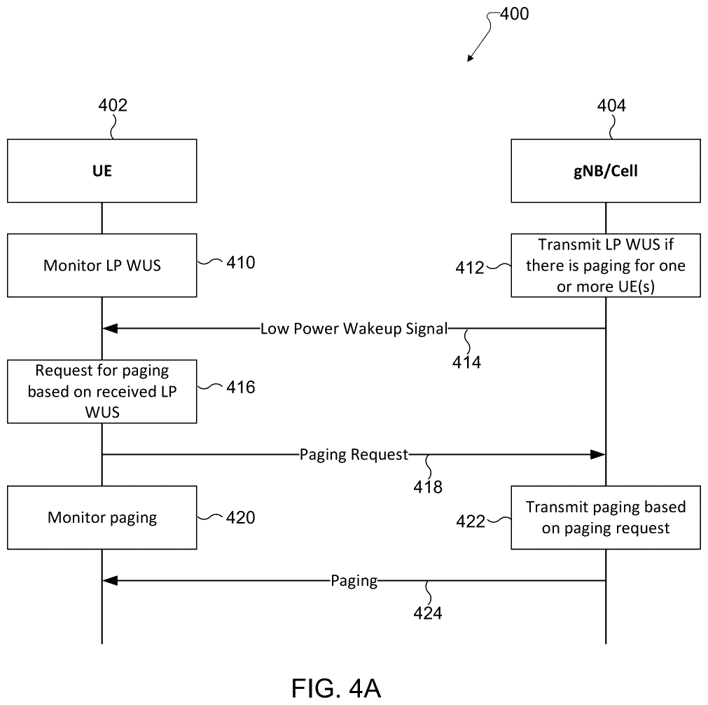

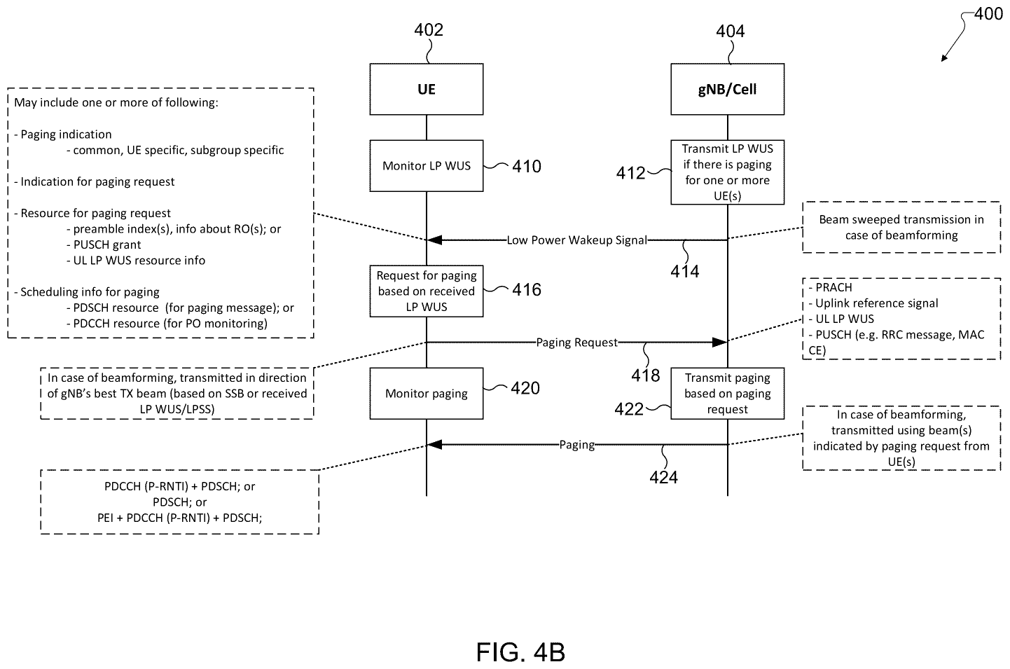

FIGS. 4A-4B illustrate a method 400 for on demand paging according to embodiments of the present disclosure. An embodiment of the method illustrated in FIGS. 4A-4B is for illustration only. One or more of the components illustrated in FIGS. 4A-4B may be implemented in specialized circuitry configured to perform the noted functions or one or more of the components may be implemented by one or more processors executing instructions to perform the noted functions. Other embodiments for on demand paging could be used without departing from the scope of this disclosure.

The example of FIGS. 4A-4B shows a UE 402 and a gNB/Cell 404. UE 402 may be similar as described regarding UE 116 of FIG. 1, and gNB/Cell 104 may be similar as described regarding BS 102 of FIG. 1.

In the example of FIGS. 4A-4B, UE 402 may be in an RRC_IDLE or RRC_INACTIVE state, and UE 402 has acquired the system information (SI) of the camped cell. UE 402 may receive CN paging (in the RRC_IDLE and in the RRC_INACTIVE state), RAN paging (in the RRC_INACTIVE state), system information update notifications, and Earthquake and Tsunami Warning System (ETWS)/Commercial Mobile Alert System (CMAS) notifications from the camped cell.

At block 410, UE 402 may monitor for a LP WUS under any combination of the following conditions:
UE 402 supports a LP WUS
UE 402 is camped in a cell supporting a LP WUS
cell quality or RSRP of the DL path loss reference is below a configured threshold and/or gNB 404 has indicated to monitor for a LP WUS for UE 402's (paging) subgroup
gNB 404 has indicated for UE 402 to monitor for a LP WUS in an RRC Release message
UE 402 is in a same cell where it last received an RRCRelease message
low mobility (e.g., cell quality or RSRP of DL path loss reference has not changed above a threshold over a time interval) criteria is met
not at cell edge criteria is met
iastUsedCellOnlyLPWUS (or lastUsedCellOnly) is configured in system information of the camped cell and UE 402 most recently received RRCRelease without noLastCellUpdateLPWUS (or noLastCelUpdate) in this cell
lastUsedCellOnlyLPWUS (or lastUsedCellOnly) is not configured in system information of the camped cell.

An LR (or LP-WUR) may be used to receive the LP WUS. An LP-WUR or LR is a receiver module (e.g., the Tx and Rx modules may be implemented by hardware, software, or a combination of software and hardware in the system) operating for receiving/processing signals/channel related to low-power wake-up.

The LP WUS may be monitored on same DL carrier/frequency as the carrier/frequency on which the signals (such as PDCCH/PDSCH) by MR are received. The LP WUS can be received on a different DL carrier/frequency than the carrier/frequency on which the signals (such as PDCCH/PDSCH) by MR are received. The DL carrier/frequency for the LP WUS can be signaled by gNB 404 in SI (e.g., SIB1 or MIB or any another SIB). The DL BWP for receiving the LP WUS can be the initial DL BWP or it can be a different BWP signaled by gNB 104 in SI (e.g., SIB1 or MIB or another SIB).
UE 402's subgroup for the LP WUS can determined by UE 402 based on UE 402's UE ID or UE 402's subgroup can be assigned to UE 402 by gNB 104 or the CN (e.g., via an RRC signaling message/NAS signaling message).

At block 412, if there is paging for one or more UEs, gNB transmits an LP WUS at step 414. The LP WUS can be transmitted on the same DL carrier/frequency as the carrier/frequency on which PDCCH/PDSCH are transmitted. The LP WUS can be transmitted on a different DL carrier/frequency than the carrier/frequency on which PDCCH/PDSCH are transmitted. The DL carrier/frequency for the LP WUS can be signaled by gNB 404 in SI (e.g., SIB1 or MIB or another SIB). The DL BWP for transmitting the LP WUS can be the initial DL BWP or it can be a different BWP signaling by gNB 404 in SI (e.g., SIB1 or MIB or another SIB). The time/frequency resource information for the LP WUS transmission occasions can be signaled by gNB 404 in SI (e.g., SIB1 or MIB or another SIB). The subcarrier spacing (SCS) for the LP WUS transmission occasions can be signaled by gNB 404 in SI (e.g., SIB1 or MIB or another SIB). In one embodiment, the LP WUS is transmitted using beam sweeping, wherein the LP WUS is transmitted N*X times where N is the number of transmitted beams/SSBs/lower power synchronization signals (LPSSs), and X is the number of transmissions per transmitted beam/SSB/LPSS. X can be 1 by default. Each of these N*X transmissions can be time division multiplexed over multiple N*X transmission occasions. Each of these N*X transmission occasions are mapped to a transmitted beam/SSB/LPSS sequentially in increasing order of a transmitted beam/SSB/LPSS index. For example, if N is 3 and X is 2, 3*2 transmissions occasions are mapped to SSB 1, SSB 2, SSB 3, SSB 1, SSB 2, SSB 3 or SSB 1, SSB 1, SSB 2, SSB 2, SSB 3, SSB 3.

In one embodiment, the LP WUS includes information (e.g., a paging indication) indicating to UE 402 to wake up and monitor paging (or indicating to UE 402 to monitor paging). Information indicating to UE 402 to wake up and monitor paging may be a 1 bit information (the bit may be set to 1 or 0 to indicate for UE 402 to wake up/monitor paging or not wake up/monitor paging respectively or vice versa). In another embodiment, the LP WUS includes information indicating one or more (paging) subgroup(s) to wake up and monitor paging (indicating one or more (paging) subgroup(s) to monitor paging or indicating that there is paging for one or more (paging) subgroup(s)). Information indicating to UE 402 to wake up/monitor paging may be a 1 bit information per (paging) subgroup (the bit may be set to 1 or 0 to indicate UE's belonging to the (paging) subgroup to wake up/monitor paging or not wake up/monitor paging respectively or vice versa).

In one embodiment, the LP WUS includes information indicating to UE 402 to send a paging request (or send a response/ack to the low power wake up signal or send a presence indication) to gNB 404. This information/indication can be common for all UEs, or it can be per (paging) subgroup. The information/indication can be 1 bit set to 1 (or set to true).

In one embodiment, the LP WUS includes resource information indicating resource(s) for sending a paging request (or response/ack to the low power wake up signal or presence indication). The resource information may be one or more RACH preamble indexes, and/or one or more RACH occasion(s)/indexes. The resource information may be one or more PUSCH resource(s)/grant(s) or PUCCH resource(s) or SRS resource(s). The resources information may be UL LP WUS time/frequency resource(s) information. Note that multiple resources may be used in case of beamforming, wherein each resource corresponds to different transmission beam/SSB/LP SS of gNB 404.

In one embodiment, the LP WUS includes scheduling information for paging. The scheduling information can be a PDSCH resource where a TB including the paging message is transmitted by gNB 404. The scheduling information can be a PDCCH resource where a PDCCH addressed to a P-RNTI is transmitted by gNB 404.

At step 414, UE 402 receives the LP WUS in monitored LP WUS occasion(s). In case of beamforming where the LP WUS is transmitted in N*X occasions, UE 402 may monitor these sequentially until the LP WUS is received, or UE 402 may monitor the occasions corresponding to a suitable (RSRP above a configured threshold)/best transmitted beam/SSB/LPSS where the suitable/best transmitted beam/SSB/LPSS is identified based on a measurement of the transmitted beam/SSB/LPSS.

Upon receiving the LP WUS, UE 402 requests for paging (block 416) i.e., at step 418, UE 402 transmits a paging request (or sends a response/ack to the low power wake up signal or sends a presence indication).

In one embodiment, upon receiving the LP WUS (or upon receiving the LP WUS for UE 402/UE 402's (paging) subgroup or upon receiving the LP WUS including information indicating to UE 402 to wake up and monitor paging (or to monitor paging) or upon receiving LP WUS information indicating to UE 402's paging subgroup to wake up and monitor paging (or to monitor paging) or upon receiving the LP WUS including a bit for UE 402's (paging) subgroup set to 1): UE 402 requests for paging i.e., UE transmits a paging request (or sends a response/ack to the low power wake up signal or sends presence indication). Information indicating to UE 402 to wake up and monitor paging may be a 1 bit information (the bit may be set to 1 or 0 to indicate for UE 402 to wake up/monitor paging or not wake up/monitor paging respectively or vice versa). In another embodiment, information indicating to UE 402 to wake up/monitor paging may be a 1 bit information per (paging) subgroup (the bit may be set to 1 or 0 to indicate UE 402's belonging to the (paging) subgroup to wake up/monitor paging or not wake up/monitor paging respectively or vice versa).

In one embodiment, upon receiving the LP WUS (or upon receiving the LP WUS for UE402/UE402's paging subgroup or upon receiving the LP WUS including information indicating to UE 402 to wake up and monitor paging or upon receiving LP WUS information indicating to UE 402's paging subgroup to wake up and monitor paging or upon receiving LP WUS including a bit for UE 402's (paging) subgroup set to 1), if the indication to send a paging request/paging request configuration is included in the LP WUS: UE 402 requests for paging i.e., UE 402 transmits a paging request (or sends a response/ack to the low power wake up signal or sends a presence indication).

In one embodiment, upon receiving the LP WUS (or upon receiving the LP WUS for UE 402/UE 402's paging subgroup or upon receiving the LP WUS including information indicating to UE 402 to wake up and monitor paging or upon receiving LP WUS information indicating to UE 402's paging subgroup to wake up and monitor paging or upon receiving the LP WUS including a bit for UE 402's (paging) subgroup set to 1), if the indication to send a paging request/paging request configuration is included in system information transmitted by the camped cell: UE 402 requests for paging i.e., UE 402 transmits a paging request (or sends a response/ack to the low power wake up signal or sends a presence indication).

In one embodiment, upon receiving the LP WUS (or upon receiving the LP WUS for UE402/UE402's paging subgroup or upon receiving the LP WUS including information indicating to UE 402 to wake up and monitor paging or upon receiving LP WUS information indicating to UE 402's paging subgroup to wake up and monitor paging or upon receiving the LP WUS including a bit for UE 402's (paging) subgroup set to 1), if the indication to send a paging request is included in the LP WUS and if the paging request configuration is included in system information transmitted by the camped cell: UE 402 requests for paging i.e., UE 402 transmits a paging request (or sends a response/ack to the low power wake up signal or sends a presence indication).

In one embodiment, in case of beamforming, the transmission at step 418 (i.e., paging request or response/ack to the low power wake up signal or presence indication) is in the direction/coverage of gNB 404's best TX beam (based on a SSB or received LP WUS or received LP SS). In case the number of gNB 404 TX beams/SSBs/LPSSs is N, there can be N (or N*X, where X is the number of transmission occasions (or resources) per TX beam/SSB/LP SS) transmission occasions (or resources) for transmitting the paging request and each of these is uniquely mapped to gNB 404's TX beam/SSB/LP SS. UE 402 transmits the paging request in a transmission occasion (or resource) corresponding to gNB 404's best/suitable (e.g., the RSRP of the TX beam/SSB/LP SS is above a configured threshold) TX beam/SSB/LP SS. N can be 1. These N (or N*X) transmission occasions (or resources) can be common for all UEs, or these can be per group of UEs (per subgroup) wherein UE 402 selects the transmission occasion (or resource) amongst the N (or N*X) transmission occasions (or resources) of its group.

In one embodiment, UE 402 transmits the paging request (or sends a response/ack to the low power wake up signal or sends a presence indication) in a resource wherein the resource(s)/resource index(s) (time/frequency/preamble) for transmission is received by UE 402 in system information. These resource(s)/resource index(s) can be common for all UEs, or these can be per group of UEs (per subgroup) wherein UE 402 selects the resource of its group (subgroup).

In one embodiment, UE 402 transmits the paging request (or sends a response/ack to the low power wake up signal or sends a presence indication) wherein resource(s)/resource index(s) (time/frequency/preamble/RO) for the transmission is received by UE 402 in the LP WUS. These resource(s)/resource index(s) can be common for all UEs, or these can be per group of UEs (per subgroup) wherein UE 402 selects the resource of its group (subgroup).

In one embodiment, the paging request (or response/ack to the low power wake up signal or sends a presence indication) is a PRACH transmission. UE 402 transmits a PRACH preamble in a RO. In case of beamforming, UE 402 selects gNB 404's best/suitable TX beam/SSB/LP SS (the TX beam/SSB/LP SS is suitable if the RSRP of the TX beam/SSB/LP SS is above a configured threshold; the TX beam/SSB/LP SS with highest RSRP is considered best) and then selects a PRACH preamble and/or RO corresponding to the selected TX beam/SSB/LP SS and transmits the selected preamble in the selected RO. The selected preamble/RO uniquely identifies the selected TX beam/SSB/LP SS. PRACH preamble(s) and/RO(s) for this transmission are received by UE 402 in the LP WUS or system information. The preambles and/or ROs are mapped to TX beams/SSBs/LP SSs. The PRACH preamble(s) and/RO(s) for this transmission are received by UE 402 in the LP WUS or system information. The PRACH preamble(s) and/RO(s) for this transmission can be common for all UEs or these can be per group of UEs (per subgroup) wherein UE 402 selects from PRACH preamble(s) and/RO(s) of its group (subgroup). In one embodiment, for PRACH preamble(s), UE 402 may receive ra-PreambleStartIndex in the LP WUS or system information. If N SSBs/gNB TX beams/LP SSs are associated with a RACH occasion, where N>=1, for the i-th SSB/TX beam/LPSS (i=0, . . . , N−1) the preamble with preamble index=ra-PreambleStartIndex+i is used for the paging request (or response/ack to the low power wake up signal or presence indication); For N<1, the preamble with preamble index=ra-PreambleStartIndex is used for the paging request (or response/ack to the low power wake up signal or presence indication). In one embodiment, for PRACH preamble(s), UE 402 may receive ra-PreambleStartIndex in the LP WUS or system information. The preamble with preamble index=ra-PreambleStartIndex is used for the paging request (or response/ack to the low power wake up signal or presence indication).

In one embodiment, the paging request (or response/ack to the low power wake up signal or sends a presence indication) is a PUSCH transmission. UE 402 transmits a MAC PDU in a PUSCH where the MAC PDU includes a MAC CE or RRC message indicating the paging request (or response/ack to the low power wake up signal or sends a presence indication). Information in the MAC CE/RRC may indicate the paging request or information in the MAC CE/RRC may include information about UE 402's (paging) subgroup or UE identity. In case of beamforming, UE 402 selects gNB 404's best/suitable TX beam/SSB/LP SS and then selects a PUSCH grant corresponding to the selected TX beam/SSB/LP SS and transmits in the selected PUSCH grant. PUSCH grant(s)/PUSCH resource index(s) for this transmission are received by UE 402 in the LP WUS or system information. PUSCH grant(s)/PUSCH resource index(s) for this transmission can be common for all UEs or these can be per group of UEs (per subgroup) wherein UE 402 selects from PUSCH grant(s)/PUSCH resource index(s) of its group (subgroup).

In one embodiment, the paging request (or response/ack to the low power wake up signal or presence indication) is a PUCCH transmission. In case of beamforming, UE 402 selects gNB 404's best/suitable TX beam/SSB/LP SS and then selects a PUCCH resource corresponding to the selected TX beam/SSB/LP SS and transmits in the selected PUCCH resource. The PUCCH resource(s)/PUCCH resource index(s) for this transmission are received by UE 402 in the LP WUS or system information. PUCCH index(s) for this transmission are received by UE 402 in the LP WUS or system information. PUCCH resource(s)/PUCCH resource index(s) for this transmission can be common for all UEs or these can be per group of UEs (per subgroup) wherein UE 402 selects from PUCCH resource(s)/PUCCH resource index(s) of its group (subgroup).

In one embodiment, the paging request (or response/ack to the low power wake up signal or presence indication) is a reference signaling (e.g., SRS) transmission. In case of beamforming, UE 402 selects gNB 404's best/suitable TX beam/SSB/LP SS and then select an SRS resource corresponding to the selected TX beam/SSB/LP SS and transmits in the selected SRS resource. SRS resource(s)/SRS resource index(s) for this transmission are received by UE 402 in the LP WUS or system information. SRS resource(s)/SRS resource index(s) for this transmission can be common for all UEs or these can be per group of UEs (per subgroup) wherein UE 402 selects from SRS resource(s)/SRS resource index(s) of its group (subgroup).

Upon transmitting the paging request (or response/ack to the low power wake up signal or presence indication), at block 420 UE 402 monitors for paging as follows:
UE 402 may receive a PDCCH (addressed to P-RNTI) in a PO followed by a PDSCH (TB including paging message); or
UE 402 may receive a PDSCH (TB including a paging message); In this case scheduling information for the PDSCH may be already indicated in the transmitted LP WUS; or
UE 402 may receive a PDCCH (addressed to P-RNTI) in a PEI occasion, followed by a PDCCH (addressed to P-RNTI) in a PO followed by a PDSCH (TB including a paging message).

If gNB 404 receives the paging request (or response/ack to the low power wake up signal or presence indication) from at least one UE (step 418), gNB 404 transmits paging at block 422/step 424. In one embodiment, if gNB 404 receives the paging request (or response/ack to the low power wake up signal or presence indication) from at least one UE of the (paging) subgroup for which it has indicated paging in the LP WUS (Note that gNB 404 can know about this based on mapping between the resource and the (paging) subgroup and reception of the paging request in the resource mapped to the (paging) subgroup or based on information included in the paging request), gNB 404 transmits paging (step 424). In case of beamforming, gNB 404 transmits paging in the direction/coverage of TX beams(s)/SSB(s)/LP SS(s) indicated by each received paging request (or response/ack to the low power wake up signal or presence indication). The resource (PRACH/PUCCH/PUSCH/SRS) for the paging request (or response/ack to the low power wake up signal or presence indication) is mapped to TX beams(s)/SSB(s)/LP SS(s) of gNB 404. Based on the resource in which the paging request (or response/ack to the low power wake up signal or presence indication) is received, gNB 404 can identify the TX beams(s)/SSB(s)/LP SS(s). In case gNB 404 has transmitted the LP WUS for one or more UEs in a cell and none of these UEs are in the cell, gNB 404 will not receive the paging request and unnecessary paging transmission can be avoided. In case gNB 404 has transmitted the LP WUS for one or more UEs in a cell and these UEs are in the cell in coverage of a subset of TX beams(s)/SSB(s)/LP SS(s), gNB 404 will receive the paging request only for a subset of TX beams(s)/SSB(s)/LP SS(s), and unnecessary paging transmission on other TX beams(s)/SSB(s)/LP SS(s) can be avoided. For paging,
gNB 404 may transmit a PDCCH (addressed to a P-RNTI) in a PO followed by a PDSCH (TB including the paging message); or
gNB 404 may transmit a PDSCH (TB including the paging message); In this case scheduling information for the PDSCH may be already indicated in the transmitted LP WUS; or
gNB 404 may transmit a PDCCH (addressed to a P-RNTI) in a PEI occasion, followed by a PDCCH (addressed to a P-RNTI) in a PO followed by a PDSCH (TB including the paging message).

Although FIGS. 4A-4B illustrate one example of a method 400 for on demand paging, various changes may be made to FIGS. 4A-4B. For example, while shown as a series of steps, various steps in FIGS. 4A-4B could overlap, occur in parallel, occur in a different order, occur any number of times, be omitted, or replaced by other steps.

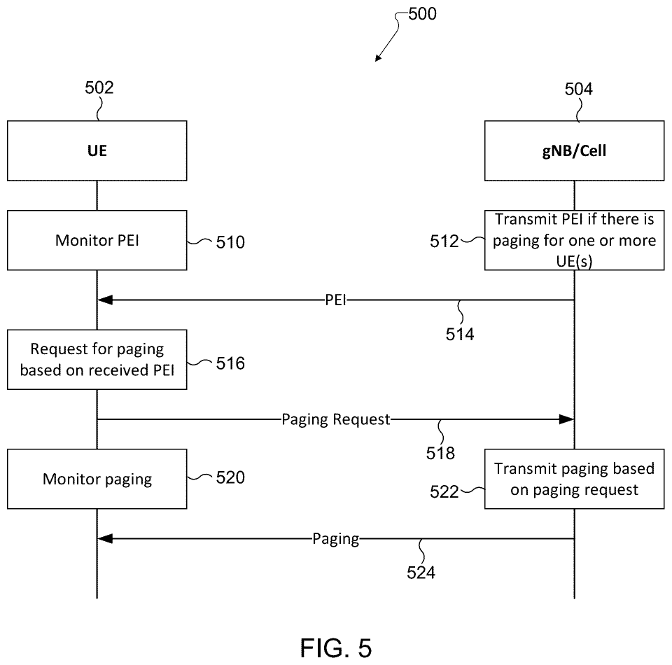

FIG. 5 illustrates another method 500 for on demand paging according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments for on demand paging could be used without departing from the scope of this disclosure.

The example of FIG. 5 shows a UE 502 and a gNB/Cell 504. UE 502 may be similar as described regarding UE 116 of FIG. 1, and gNB/Cell 504 may be similar as described regarding BS 102 of FIG. 1.

In the example of FIG. 5, UE 502 may be in an RRC_IDLE or RRC_INACTIVE state, and UE 502 has acquired the system information (SI) of the camped cell. UE 502 may receive CN paging (in the RRC_IDLE and in the RRC_INACTIVE state), RAN paging (in the RRC_INACTIVE state), system information update notifications, and Earthquake and Tsunami Warning System (ETWS)/Commercial Mobile Alert System (CMAS) notifications from the camped cell.

At block 510, UE 502 may monitor for a PEI (the PEI may be a PDCCH addressed to a P-RNTI transmitted in a PEI-occasion) under any combination of the following conditions:
UE 502 supports PEI
UE 502 is camped in a cell supporting PEI
UE 502 is in same cell where it last received an RRCRelease message
lastUsedCellOnly is configured in system information of the camped cell and UE 502 most recently received RRCRelease without noLastCelUpdate in this cell
lastUsedCellOnly is not configured in system information of the camped cell.

MR may be, used to receive PEI.

UE 502's subgroup for PEI can determined by UE 502 based on its UE ID or it can be assigned to UE 502 by gNB 504 or the CN (e.g., via an RRC signaling message/NAS signaling message).

At block 512, if there is paging for one or more UEs, gNB 504 transmits a PEI at step 514. In one embodiment, the PEI is transmitted using beam sweeping, wherein the PEI is transmitted N*X times where N is the number of transmitted beams/SSBs/lower power synchronization signals (LPSSs), and X is number of transmissions per transmitted beam/SSB/LPSS. X can be 1 by default. Each of these N*X transmissions can be time division multiplexed over multiple N*X transmission occasions. Each of these N*X transmission occasions are mapped to a transmitted beam/SSB/LPSS sequentially in increasing order of a transmitted beam/SSB/LPSS index. For example, if N is 3 and X is 2, 3*2 transmissions occasions are mapped to SSB 1, SSB 2, SSB 3, SSB 1, SSB 2, SSB 3 or SSB 1, SSB 1, SSB 2, SSB 2, SSB 3, SSB 3.

In one embodiment, the PEI includes information (e.g., a paging indication) indicating to UE 502 to wake up and monitor paging (i.e., a PDCCH in a PO and/or PDSCH) or indicating to UE 502 to monitor paging. Information indicating to UE 502 to wake up and monitor paging (or monitor paging) may be a 1 bit information (the bit may be set to 1 or 0 to indicate for UE 502 to wake up/monitor paging or not wake up/monitor paging respectively or vice versa). In another embodiment, the PEI includes information indicating one or more (paging) subgroup(s) to wake up and monitor paging (or to monitor paging). Information indicating to UE 502 to wake up/monitor paging may be a 1 bit information per (paging) subgroup (the bit may be set to 1 or 0 to indicate UE's belonging to the (paging) subgroup to wake up/monitor paging or not wake up/monitor paging respectively or vice versa).

In one embodiment, the PEI includes information indicating to UE 502 to send a paging request (or send a response/ack to the PEI or send a presence indication) to gNB 504. This information/indication can be common for all UEs, or it can be per (paging) subgroup. The information/indication can be 1 bit set to 1 (or set to true).

In one embodiment, the PEI includes resource information indicating resources for sending a paging request (or response/ack to the PEI or presence indication). The resource information may be one or more RACH preamble indexes, or one or more RACH occasion(s)/indexes. The resource information may be one or more PUSCH resource(s)/grant(s) or PUCCH resource(s) or SRS resource(s). The resources information may be PEI time/frequency resource(s) information. Note that multiple resources may be needed in case of beamforming wherein each resource corresponds to different transmission beam/SSB/LP SS of gNB 504.

In one embodiment, the PEI includes scheduling information for paging. The scheduling information can be a PDSCH resource where a TB including the paging message is transmitted by gNB 504. The scheduling information can be a PDCCH resource where a PDCCH addressed to a P-RNTI is transmitted by gNB 504.

At step 514, UE 502 receives the PEI in monitored PEI occasion(s). In case of beamforming where the PEI is transmitted in N*X occasions, UE 502 may monitor these sequentially until the PEI is received or UE 502 may monitor the occasions corresponding to a suitable (RSRP above a configured threshold)/best transmitted beam/SSB/LPSS where the suitable/best transmitted beam/SSB/LPSS is identified based on a measurement of the transmitted beam/SSB/LPSS.

Upon receiving the PEI, UE 502 requests for paging (block 516) i.e., UE 502 transmits a paging request (or sends a response/ack to the PEI or sends a presence indication).

In one embodiment, upon receiving the PEI (or upon receiving the PEI for UE 502/UE 502's (paging) subgroup or upon receiving the PEI including information indicating to UE 502 to wake up and monitor paging (or indicating to UE 502 to monitor paging) or upon receiving the PEI information indicating to UE 502's paging subgroup to wake up and monitor paging (or indicating to UE 502's paging subgroup to monitor paging) or upon receiving the PEI including a bit for UE 502's (paging) subgroup set to 1): UE 502 requests for paging i.e., UE 502 transmits a paging request (or sends a response/ack to the PEI or sends a presence indication). Information indicating to UE 502 to wake up and monitor paging may be a 1 bit information (the bit may be set to 1 or 0 to indicate UE 502 to wake up/monitor paging or not wake up/monitor paging respectively or vice versa). In another embodiment, information indicating to UE 502 to wake up/monitor paging may be a 1 bit information per (paging) subgroup (the bit may be set to 1 or 0 to indicate UE 502's belonging to the (paging) subgroup to wake up/monitor paging or not wake up/monitor paging respectively or vice versa).

In one embodiment, upon receiving the PEI (or upon receiving the PEI for UE 502/UE 502's paging subgroup or upon receiving the PEI including information indicating to UE 502 to wake up and monitor paging (or indicating to UE 502 to monitor paging) or upon receiving the PEI information indicating to UE 502's paging subgroup to wake up and monitor paging (or indicating to UE 502's paging subgroup to wake up and monitor paging) or upon receiving the PEI including a bit for UE 502's (paging) subgroup set to 1), if the indication to send a paging request/paging request configuration is included in the PEI: UE 502 requests for paging i.e., UE 502 transmits a paging request (or sends a response/ack to the PEI or sends a presence indication).

In one embodiment, upon receiving the PEI (or upon receiving the PEI for UE 502/UE 502's paging subgroup or upon receiving the PEI including information indicating to UE 502 to wake up and monitor paging or upon receiving the PEI information indicating to UE 502's paging subgroup to wake up and monitor paging or upon receiving the PEI including a bit for UE 502's (paging) subgroup set to 1), if the indication to send a paging request/paging request configuration is included in system information transmitted by the camped cell: UE 502 requests for paging i.e., UE 502 transmits a paging request (or sends a response/ack to the PEI or sends a presence indication).

In one embodiment, in case of beamforming, transmission at step 518 (i.e., paging request/response/ack to the PEI/presence indication) is in direction/coverage of gNB 504's best TX beam (based on a SSB or received PEI or received LP SS). In case the number of gNB 504 TX beams/SSBs/LPSSs is N, there can be N (or N*X, where X is the number of transmission occasions per TX beam/SSB/LP SS) transmission occasions for transmitting the paging request and each of these is uniquely mapped to gNB 504's TX beam/SSB/LP SS. UE 502 transmits the paging request in a transmission occasion corresponding to gNB 504's best/suitable (e.g., the RSRP of the TX beam/SSB/LP SS is above a configured threshold) TX beam/SSB/LP SS. N can be 1. These N (or N*X) transmission occasions can be common for all UEs, or these can be per group of UEs (per subgroup) wherein UE 502 selects the transmission occasion amongst the N (or N*X) transmission occasions of its group.

In one embodiment, UE 502 transmits the paging request (or sends a response/ack to the PEI or sends a presence indication) in a resource wherein the resource(s)/resource index(s) (time/frequency/preamble) for transmission is received by UE 502 in system information. These resource(s)/resource index(s) can be common for all UEs, or these can be per group of UEs (per subgroup) wherein UE 402 selects the resource of its group (subgroup).

In one embodiment, UE 502 transmits the paging request (or sends a response/ack to the PEI or sends a presence indication) wherein the resource(s)/resource index(s) (time/frequency/preamble/RO) for transmission is received by UE 502 in the PEI. These resource(s)/resource index(s) can be common for all UEs, or these can be per group of UEs (per subgroup) wherein UE 502 selects the resource of its group (subgroup).

In one embodiment, the paging request (or response/ack to PEI or presence indication) is a PRACH transmission. UE 502 transmits a PRACH preamble in a RO. In case of beamforming, UE 502 selects gNB 504's best/suitable TXbeam/SSB/LP SS (the TXbeam/SSB/LP SS is suitable if the RSRP of the TX beam/SSB/LP SS is above a configured threshold; the TX beam/SSB/LP SS with the highest RSRP is considered best) and then selects a PRACH preamble and/or RO corresponding to the selected TX beam/SSB/LP SS and transmits the selected preamble in the selected RO. The selected preamble/RO uniquely identifies the selected TX beam/SSB/LP SS. PRACH preamble(s) and/RO(s) for this transmission are received by UE 502 in the PEI or system information. Preambles and/or ROs are mapped to TX beams/SSBs/LP SSs. PRACH preamble(s) and/RO(s) for this transmission are received by UE 502 in the PEI or system information. PRACH preamble(s) and/RO(s) for this transmission can be common for all UEs or these can be per group of UEs (per subgroup) wherein UE 502 selects from PRACH preamble(s) and/RO(s) of its group (subgroup). In one embodiment, for PRACH preamble(s), UE 502 may receive ra-PreambleStartIndex in the PEI or system information. If N SSBs/gNB TX beams/LP SSs are associated with a RACH occasion, where N>=1, for the i-th SSB/TX beam/LPSS (i=0, . . . , N−1) the preamble with preamble index=ra-PreambleStartIndex+i is used for the paging request (or response/ack to the low power wake up signal or presence indication). For N<1, the preamble with preamble index=ra-PreambleStartIndex is used for the paging request (or response/ack to the low power wake up signal or presence indication). In one embodiment, for PRACH preamble(s), UE 502 may receive ra-PreambleStartIndex in the PEI or system information. The preamble with preamble index=ra-PreambleStartIndex is used for the paging request (or response/ack to the low power wake up signal or presence indication).

In one embodiment, the paging request (or response/ack to the PEI or presence indication) is a PUSCH transmission. UE 502 transmits a MAC PDU in a PUSCH where the MAC PDU includes a MAC CE or RRC message indicating the paging request (or response/ack to the PEI or presence indication). Information in the MAC CE/RRC may indicate the paging request or information in the MAC CE/RRC may include information about UE 502's (paging) subgroup or UE identity. In case of beamforming, UE 502 selects the gNB 504's best/suitable TX beam/SSB/LP SS and then selects a PUSCH grant corresponding to the selected TX beam/SSB/LP SS and transmits in the selected PUSCH grant. PUSCH grant(s)/PUSCH resource index(s) for this transmission a received by UE 502 in the PEI or system information. PUSCH grant(s)/PUSCH resource index(s) for this transmission can be common for all UEs or these can be per group of UEs (per subgroup) wherein UE 502 selects from PUSCH grant(s)/PUSCH resource index(s) of its group (subgroup).

In one embodiment, the paging request (or response/ack to the PEI or presence indication) is a PUCCH transmission. In case of beamforming, UE 502 selects gNB 504's best/suitable TX beam/SSB/LP SS and then selects a PUCCH resource corresponding to the selected TX beam/SSB/LP SS and transmits in the selected PUCCH resource. The PUCCH resource(s)/PUCCH resource index(s) for this transmission are received by UE 502 in the PEI or system information. PUCCH resource(s)/PUCCH resource index(s) for this transmission can be common for all UEs or these can be per group of UEs (per subgroup) wherein UE 502 selects from PUCCH resource(s)/PUCCH resource index(s) of its group (subgroup).

In one embodiment, the paging request (or response/ack to the PEI or presence indication) is a reference signaling (e.g., SRS) transmission. In case of beamforming, UE 502 selects gNB 504's best/suitable TX beam/SSB/LP SS and then select an SRS resource corresponding to the selected TX beam/SSB/LP SS and transmits in the selected SRS resource. SRS resource(s)/SRS resource index(s) for this transmission are received by UE 502 in the PEI or system information. SRS resource(s)/SRS resource index(s) for this transmission can be common for all UEs or these can be per group of UEs (per subgroup) wherein UE 502 selects from SRS resource(s)/SRS resource index(s) of its group (subgroup).

Upon transmitting the paging request (or response/ack to the PEI or presence indication), at block 520 UE 502 monitors for paging as follows:
UE 502 may receive a PDCCH (addressed to a P-RNTI) in a PO followed by a PDSCH (TB including paging message); or
UE 502 may receive a PDSCH (TB including paging message); In this case scheduling information for PDSCH may be already indicated in transmitted PEI.

If gNB 504 receives the paging request (or response/ack to the PEI or presence indication) from at least one UE (step 518), gNB 504 transmits paging at block 522/step 524. In one embodiment, if gNB 504 receives the paging request (or response/ack to the PEI or presence indication) from at least one UE of (paging) subgroup for which it has indicated paging in the PEI (Note that gNB 504 can know about this based on mapping between the resource and the (paging) subgroup and reception of the paging request (or response/ack to the PEI or presence indication) in the resource mapped to the (paging) subgroup or based on information included in the paging request), gNB 504 transmits paging (step 524). In case of beamforming, gNB 504 transmits the paging in the direction/coverage of TX beams(s)/SSB(s)/LP SS(s) indicated by each received paging request (or response/ack to the PEI or presence indication). The resource (PRACH/PUCCH/PUSCH/SRS) for the paging request (or response/ack to the PEI or presence indication) is mapped to the TX beams(s)/SSB(s)/LP SS(s) of gNB 504. Based on the resource in which the paging request (or response/ack to the PEI or presence indication) is received, gNB 504 can identify the TX beams(s)/SSB(s)/LP SS(s). In case gNB 504 has transmitted the PEI for one or more UEs in a cell and none of these UEs are in the cell, gNB 504 will not receive the paging request (or response/ack to the PEI or presence indication) and unnecessary paging transmission can be avoided. In case gNB 504 has transmitted the PEI for one or more UEs in a cell and these UEs are in the cell in coverage of a subset of TX beams(s)/SSB(s)/LP SS(s), gNB 504 will receive the paging request (or response/ack to the PEI or presence indication) for a subset of TX beams(s)/SSB(s)/LP SS(s), and unnecessary paging transmission on other TX beams(s)/SSB(s)/LP SS(s) can be avoided. For paging,
gNB 504 may transmit a PDCCH (addressed to a P-RNTI) in a PO followed by a PDSCH (TB including the paging message); or
gNB 504 may transmit PDSCH (TB including the paging message); In this case scheduling information for the PDSCH may be already indicated in the transmitted PEI.

Although FIG. 5 illustrates one example of a method 500 for on demand paging, various changes may be made to FIG. 5. For example, while shown as a series of steps, various steps in FIG. 5 could overlap, occur in parallel, occur in a different order, occur any number of times, be omitted, or replaced by other steps.

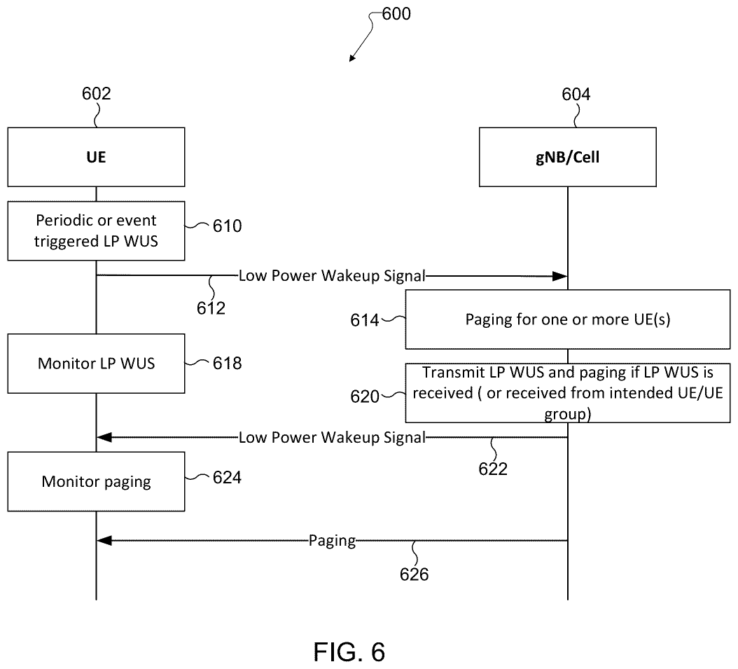

FIG. 6 illustrates another method 600 for on demand paging according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments for on demand paging could be used without departing from the scope of this disclosure.

The example of FIG. 6 shows a UE 602 and a gNB/Cell 604. UE 602 may be similar as described regarding UE 116 of FIG. 1, and gNB/Cell 604 may be similar as described regarding BS 102 of FIG. 1.

In the example of FIG. 6, UE 602 may be in an RRC_IDLE or RRC_INACTIVE state, and UE 602 has acquired the system information (SI) of the camped cell. UE 602 may receive CN paging (in the RRC_IDLE and in the RRC_INACTIVE state), RAN paging (in the RRC_INACTIVE state), system information update notifications, and Earthquake and Tsunami Warning System (ETWS)/Commercial Mobile Alert System (CMAS) notifications from the camped cell.

At block 610 and step 612, UE 602 may transmit an LP WUS under any combination of the following conditions:
UE 602 supports the LP WUS and/or is camped in a cell supporting the LP WUS
cell quality or RSRP of the DL path loss reference is below a configured threshold
gNB 604 has indicated to transmit the LP WUS for UE 602's (paging) subgroup
gNB 604 has indicated for UE 602 to transmit or receive the LP WUS in a RRC Release message
UE 602 is in a same cell where it last received an RRCRelease message
low mobility (e.g., cell quality or RSRP of the DL path loss reference has not changed above a threshold over a time interval) criteria is met
not at cell edge criteria is met
If lastUsedCellOnlyLPWUS (or lastUsedCellOnly) is configured in system information of the camped cell and UE 602 most recently received RRCRelease without noLastCellUpdateLPWUS (or noLastCellUpdate) in this cell
If lastUsedCellOnlyLPWUS (or lastUsedCellOnly) is not configured in system information of the camped cell.

The LP WUS may be transmitted by UE 602 on the same UL carrier/frequency as the carrier/frequency on which the signals (such as PUSCH/PUCCH) are transmitted by UE 602. The LP WUS may be transmitted by UE 602 on a different UL carrier/frequency than the carrier/frequency on which the signals (such as PUSCH/PUCCH) are transmitted by UE 602. The UL carrier/frequency for the LP WUS transmission by UE 602 can be signaled by gNB 604 in SI (e.g., SIB1 or MIB or any another SIB). The UL BWP for transmitting the LP WUS by UE 602 can be the initial UL BWP, or it can be a different UL BWP signaled by gNB 604 in SI (e.g., SIB1 or MIB or another SIB).

UE 602's subgroup for the LP WUS can determined by UE 602 based on its UE ID or it can be assigned to UE 602 by gNB 604 or the CN (e.g., via an RRC signaling message/NAS signaling message).

UE 602 may transmit the LP WUS periodically or UE 602 may transmit the LP WUS when a time since the last transmission of an LP WUS in the camped cell exceeds a certain threshold (configurable by gNB 604) or UE 602 may transmit the LP WUS when UE 602 enters (e.g., selects or reselects a cell) or UE 602 may transmit the LP WUS when the RSRP of cell is below a threshold or UE 602 may transmit the LP WUS when the RSRP of cell is above a threshold or UE 602 may transmit the LP WUS when the RSRP of cell is below a threshold 1 and greater than a threshold 2. The thresholds can be configured/signaled by gNB 604 to UE 602.

In one embodiment, in case of beamforming, the transmission of step 612 is in the direction/coverage of gNB 604's best TX beam (based on an SSB or received LP SS). In case the number of gNB 604 TX beams/SSBs/LPSSs is N, there can be N (or N*X, where X is the number of transmission occasions per TX beam/SSB/LP SS) transmission occasions for transmitting the LP WUS and each of these is uniquely mapped to gNB 604's TX beam/SSB/LP SS. UE 602 transmits the LP WUS in a transmission occasion corresponding to gNB 604's best/suitable (e.g., RSRP above a configured threshold) TX beam/SSB/LP SS. N can be 1. These N (or N*X) transmission occasions can be common for all UEs, or these can be per group of Ues (per subgroup) wherein UE 602 selects the transmission occasion amongst the N (or N*X) transmission occasions of its group.

In one embodiment, UE 602 transmits the LP WUS in a resource wherein resource(s)/resource index(s) (time/frequency/preamble) for the LP WUS transmission are received by UE 602 in system information. These resource(s)/resource index(s) can be common for all Ues, or these can be per group of Ues (per subgroup) wherein UE 602 selects the resource of its group (subgroup).

In one embodiment, the LP WUS is a PRACH transmission. UE 602 transmits a PRACH preamble in a RO. In case of beamforming, UE 602 selects gNB 604's best/suitable TX beam/SSB/LP SS and then selects a PRACH preamble and/or RO corresponding to the selected TX beam/SSB/LP SS and transmits the selected preamble in the selected RO. The selected preamble/RO uniquely identifies the selected TX beam/SSB/LP SS. PRACH preamble(s) and/RO(s) for this transmission are received by UE 602 in system information. Preambles and/or ROs are mapped to TX beams/SSBs/LP SSs. PRACH preamble(s) and/RO(s) for this transmission are received by UE 602 in system information. PRACH preamble(s) and/RO(s) for this transmission can be common for all UEs or these can be per group of UEs (per subgroup) wherein UE 602 selects from PRACH preamble(s) and/RO(s) of its group (subgroup). In one embodiment, for PRACH preamble(s), UE 602 may receive ra-PreambleStartIndex in an LP WUS or system information; if N SSBs/gNB TX beams/LP SSs are associated with a RACH occasion, where N>=1, for the i-th SSB/TX beam/LPSS (i=0, . . . , N−1) the preamble with preamble index=ra-PreambleStartIndex+i is used for the LP WUS. For N<1, the preamble with preamble index=ra-PreambleStartIndex is used for the LP WUS. In one embodiment, for PRACH preamble(s), UE may receive ra-PreambleStartIndex in system information. The preamble with preamble index=ra-PreambleStartIndex is used for the LP WUS.

In one embodiment, the LP WUS is a PUSCH transmission. UE 602 transmits a MAC PDU in a PUSCH where the MAC PDU includes a MAC CE or a RRC message. Information in the MAC CE/RRC may indicate presence or the MAC CE/RRC may include information about UE 602's (paging) subgroup or UE identity. In case of beamforming, UE 602 selects the gNB's best/suitable TX beam/SSB/LP SS and then selects a PUSCH grant corresponding to the selected TX beam/SSB/LP SS and transmits in the selected PUSCH grant. PUSCH grant(s)/PUSCH resource index(s) for this transmission are received by UE 602 in system information. PUSCH grant(s)/PUSCH resource index(s) for this transmission can be common for all Ues or these can be per group of Ues (per subgroup) wherein UE 602 selects from PUSCH grant(s)/PUSCH resource index(s) of its group (subgroup).

In one embodiment, the LP WUS is a PUCCH transmission. In case of beamforming, UE 602 selects gNB 604's best/suitable TX beam/SSB/LP SS and then selects a PUCCH resource corresponding to the selected TX beam/SSB/LP SS and transmits in the selected PUCCH resource. PUCCH resource(s)/PUCCH resource index(s) for this transmission are received by UE 602 in system information. PUCCH index(s) for this transmission are received by UE 602 in system information. PUCCH resource(s)/PUCCH resource index(s) for this transmission can be common for all UEs or these can be per group of UEs (per subgroup) wherein UE 602 selects from PUCCH resource(s)/PUCCH resource index(s) of its group (subgroup).

In one embodiment, the LP WUS is a reference signaling (e.g., SRS) transmission. In case of beamforming, UE 602 selects the gNB 604's best/suitable TX beam/SSB/LP SS and then select an SRS resource corresponding to the selected TX beam/SSB/LP SS and transmits in the selected SRS resource. SRS resource(s)/SRS resource index(s) for this transmission are received by UE 602 in system information. SRS resource(s)/SRS resource index(s) for this transmission can be common for all Ues or these can be per group of Ues (per subgroup) wherein UE 602 selects from SRS resource(s)/SRS resource index(s) of its group (subgroup).

If there is paging for one or more Ues at block 614, gNB 604 transmits an LP WUS at block 620 and step 622. The LP WUS can be transmitted on the same DL carrier/frequency as the carrier/frequency on which PDCCH/PDSCH are transmitted. The LP WUS can be transmitted on a different DL carrier/frequency than the carrier/frequency on which PDCCH/PDSCH are transmitted. The DL carrier/frequency for the LP WUS can be signaled by gNB 604 in SI (e.g., SIB1 or MIB or another SIB). The DL BWP for transmitting the LP WUS can be the initial DL BWP or it can be a different BWP signaling by gNB 604 in SI (e.g., SIB1 or MIB or another SIB). The time/frequency resource information for LP WUS transmission occasions can be signaled by gNB 604 in SI (e.g., SIB1 or MIB or another SIB). The subcarrier spacing (SCS) for LP WUS transmission occasions can be signaled by gNB in SI (e.g., SIB1 or MIB or another SIB).

If there is paging for one or more Ues (block 614) and gNB 604 has received (the reception may be in a pre-defined interval or period) the LP WUS from at least one UE in its cell (step 612), gNB transmits an LP WUS and paging at steps 622 and 626. In one embodiment, if gNB 604 has received the LP WUS from at least one UE of a (paging) subgroup for which there is paging (Note that gNB 604 can know about this based on mapping between a resource and (paging) subgroup and reception of the LP WUS in the resource mapped to the (paging) subgroup), gNB 604 transmits an LP WUS and paging. In case of beamforming, gNB 604 transmits the LP WUS and paging in the direction/coverage of TX beams(s)/SSB(s)/LP SS(s) indicated by each received LP WUS. The resource (PRACH/PUCCH/PUSCH/SRS) for the LP WUS from the UE is mapped to TX beams(s)/SSB(s)/LP SS(s) of gNB 604. So, based on resource in which the LP WUS is received, gNB 604 can identify the TX beams(s)/SSB(s)/LP SS(s). In case gNB 604 has paging for one or more Ues in a cell and none of these Ues are in the cell, gNB 604 will not receive the LP WUS and unnecessary paging transmission can be avoided. In case gNB 604 has paging for one or more Ues in a cell and these Ues are in the cell in coverage of a subset of TX beams(s)/SSB(s)/LP SS(s), gNB 604 will receive the LP WUS only for a subset of TX beams(s)/SSB(s)/LP SS(s), and unnecessary paging transmission on other TX beams(s)/SSB(s)/LP SS(s) can be avoided.

In one embodiment, the LP WUS includes information (e.g., a paging indication) indicating to UE 602 to wake up/monitor paging. The information indicating to UE 602 to wake up/monitor paging may be a 1 bit information (the bit may be set to 1 or 0 to indicate UE 602 to wake up/monitor paging or not wake up/monitor paging respectively or vice versa). In an alternate embodiment, the LP WUS includes information indicating one or more (paging) subgroup(s) to wake up/monitor paging. Information indicating to UE 602 to wake up/monitor paging may be a 1 bit information per (paging) subgroup (the bit may be set to 1 or 0 to indicate UE 602's belonging to the (paging) subgroup to wake up/monitor paging or not wake up/monitor paging respectively or vice versa).

In one embodiment, the LP WUS includes scheduling information for the paging. The scheduling information can be a PDSCH resource where a TB including a paging message is transmitted by gNB 604. The scheduling information can be a PDCCH resource where a PDCCH addressed to a P-RNTI is transmitted by gNB 604.

Upon transmitting the LP WUS at step 622, gNB 604 transmits paging at step 626. For paging,
gNB 604 may transmit a PDCCH (addressed to a P-RNTI) in a PO followed by a PDSCH (TB including paging message); or
gNB 604 may transmit a PDSCH (TB including paging message); In this case scheduling information for the PDSCH may be already indicated in the transmitted LP WUS; or
gNB 604 may transmit a PDCCH (addressed to P-RNTI) in a PEI occasion, followed by a PDCCH (addressed to P-RNTI) in PO followed by a PDSCH (TB including paging message).

At block 618 and step 622, UE 602 receives the LP WUS in a monitored LP WUS occasion(s). In case of beamforming where the LP WUS is transmitted in N*X occasions, UE 602 may monitor these sequentially until the LP WUS is received or UE 602 may monitor the occasions corresponding to a suitable (RSRP above a configured threshold)/best transmitted beam/SSB/LPSS where the suitable/best transmitted beam/SSB/LPSS is identified based on a measurement of the transmitted beam/SSB/LPSS.

At block 624, upon receiving LP WUS from gNB 604 at step 622, UE 602 monitors for paging as follows:
UE 602 may receive a PDCCH (addressed to P-RNTI) in a PO followed by a PDSCH (TB including paging message); or
UE 602 may receive a PDSCH (TB including paging message); In this case scheduling information for the PDSCH may be already indicated in the transmitted LP WUS; or
UE 602 may receive a PDCCH (addressed to P-RNTI) in a PEI occasion, followed by a PDCCH (addressed to P-RNTI) in a PO followed by a PDSCH (TB including paging message).

Although FIG. 6 illustrates one example of a method 600 for on demand paging, various changes may be made to FIG. 6. For example, while shown as a series of steps, various steps in FIG. 6 could overlap, occur in parallel, occur in a different order, occur any number of times, be omitted, or replaced by other steps.

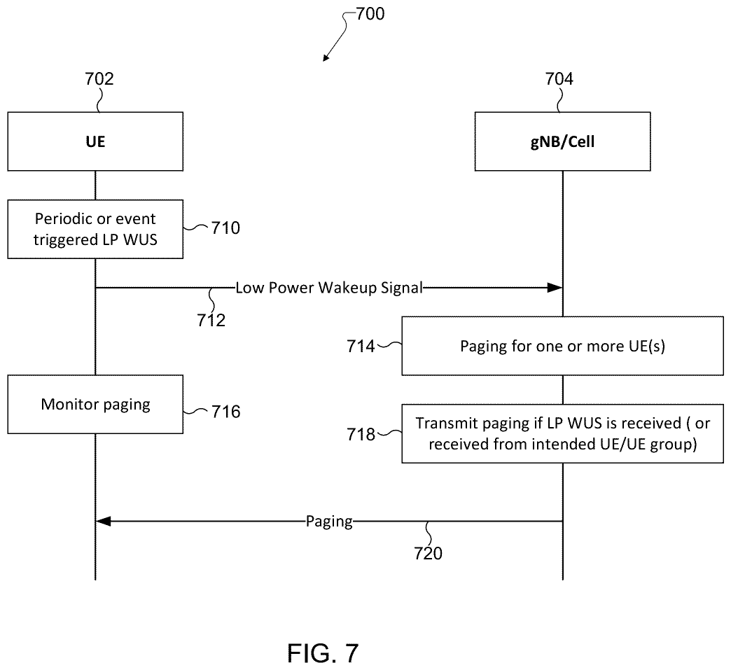

FIG. 7 illustrates another method 700 for on demand paging according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments for on demand paging could be used without departing from the scope of this disclosure.

The example of FIG. 7 shows a UE 702 and a gNB/Cell 704. UE 702 may be similar as described regarding UE 116 of FIG. 1, and gNB/Cell 704 may be similar as described regarding BS 102 of FIG. 1.

In the example of FIG. 7, UE 702 may be in an RRC_IDLE or RRC_INACTIVE state, and UE 702 has acquired the system information (SI) of the camped cell. UE 702 may receive CN paging (in the RRC_IDLE and in the RRC_INACTIVE state), RAN paging (in the RRC_INACTIVE state), system information update notifications, and Earthquake and Tsunami Warning System (ETWS)/Commercial Mobile Alert System (CMAS) notifications from the camped cell.

At block 710 and step 712, UE 702 may transmit an LP WUS under any combination of the following conditions:
UE 702 supports the LP WUS and/or is camped in a cell supporting the LP WUS
cell quality or RSRP of the DL path loss reference is below a configured threshold
gNB 704 has indicated to transmit the LP WUS for UE 702's (paging) subgroup
gNB 704 has indicated for UE 702 to transmit or receive the LP WUS in a RRC Release message
UE 702 is in a same cell where it last received an RRCRelease message
low mobility (e.g., cell quality or RSRP of the DL path loss reference has not changed above a threshold over a time interval) criteria is met
not at cell edge criteria is met
If lastUsedCellOnlyLPWUS (or lastUsedCellOnly) is configured in system information of the camped cell and UE 602 most recently received RRCRelease without noLastCellUpdateLPWUS (or noLastCelUpdate) in this cell
If lastUsedCellOnlyLPWUS (or lastUsedCellOnly) is not configured in system information of the camped cell.

The LP WUS may be transmitted by UE 702 on the same UL carrier/frequency as the carrier/frequency on which the signals (such as PUSCH/PUCCH) are transmitted by UE 702. The LP WUS may be transmitted by UE 702 on a different UL carrier/frequency than the carrier/frequency on which the signals (such as PUSCH/PUCCH) are transmitted by UE 702. The UL carrier/frequency for the LP WUS transmission by UE 702 can be signaled by gNB 704 in SI (e.g., SIB1 or MIB or any another SIB). The UL BWP for transmitting the LP WUS by UE 702 can be an initial UL BWP, or it can be a different UL BWP signaled by gNB 704 in SI (e.g., SIB1 or MIB or another SIB).

UE 702's subgroup for the LP WUS can determined by UE 702 based on its UE ID or it can be assigned to UE 702 by gNB 704 or the CN (e.g., via RRC signaling message/NAS signaling message).

UE 702 may transmit the LP WUS periodically or UE 702 may transmit the LP WUS when a time since last transmission of an LP WUS in the camped cell exceeds a certain threshold (configurable by gNB 704) or UE 702 may transmit the LP WUS when UE 702 enters (e.g., selects or reselects a cell) or UE 702 may transmit the LP WUS when the RSRP of cell is below a threshold or UE 702 may transmit the LP WUS when the RSRP of cell is above a threshold or UE 702 may transmit the LP WUS when the RSRP of cell is below a threshold 1 and greater than a threshold 2. The thresholds can be configured/signaled by gNB 704 to UE 702.

In one embodiment, in case of beamforming, the transmission of step 712 is in the direction/coverage of gNB 704's best TX beam (based on an SSB or received LP SS). In case the number of gNB 704 TX beams/SSBs/LPSSs is N, there can be N (or N*X, where X is the number of transmission occasions per TX beam/SSB/LP SS) transmission occasions for transmitting the LP WUS and each of these is uniquely mapped to gNB 704's TX beam/SSB/LP SS. UE 702 transmits the LP WUS in a transmission occasion corresponding to gNB 704's best/suitable (e.g., RSRP above a configured threshold) TX beam/SSB/LP SS. N can be 1. These N (or N*X) transmission occasions can be common for all UEs, or these can be per group of UEs (per subgroup) wherein UE 702 selects the transmission occasion amongst the N (or N*X) transmission occasions of its group.

In one embodiment, UE 702 transmits the LP WUS in a resource wherein resource(s)/resource index(s) (time/frequency/preamble) for the LP WUS transmission are received by UE 702 in system information. These resource(s)/resource index(s) can be common for all UEs, or these can be per group of UEs (per subgroup) wherein UE 702 selects the resource of its group (subgroup).

In one embodiment, the LP WUS is a PRACH transmission. UE 702 transmits a PRACH preamble in a RO. In case of beamforming, UE 702 selects gNB 704's best/suitable TX beam/SSB/LP SS and then selects a PRACH preamble and/or RO corresponding to the selected TX beam/SSB/LP SS and transmits the selected preamble in the selected RO. The selected preamble/RO uniquely identifies the selected TX beam/SSB/LP SS. PRACH preamble(s) and/RO(s) for this transmission are received by UE 702 in system information. Preambles and/or ROs are mapped to TX beams/SSBs/LP SSs. PRACH preamble(s) and/RO(s) for this transmission are received by UE 702 in system information. PRACH preamble(s) and/RO(s) for this transmission can be common for all UEs or these can be per group of UEs (per subgroup) wherein UE 702 selects from PRACH preamble(s) and/RO(s) of its group (subgroup). In one embodiment, for PRACH preamble(s), UE 702 may receive ra-PreambleStartIndex in an LP WUS or system information; if N SSBs/gNB TX beams/LP SSs are associated with a RACH occasion, where N>=1, for the i-th SSB/TX beam/LPSS (i=0, . . . , N−1) the preamble with preamble index=ra-PreambleStartIndex+i is used for the LP WUS. For N<1, the preamble with preamble index=ra-PreambleStartIndex is used for the LP WUS. In one embodiment, for PRACH preamble(s), UE may receive ra-PreambleStartIndex in system information. The preamble with preamble index=ra-PreambleStartIndex is used for the LP WUS.

In one embodiment, the LP WUS is a PUSCH transmission. UE 702 transmits a MAC PDU in a PUSCH where the MAC PDU includes a MAC CE or RRC message. Information in the MAC CE/RRC may indicate presence or the MAC CE/RRC may include information about UE 702's (paging) subgroup or UE identity. In case of beamforming, UE 702 selects gNB 704's best/suitable TX beam/SSB/LP SS and then selects a PUSCH grant corresponding to the selected TX beam/SSB/LP SS and transmits in the selected PUSCH grant. PUSCH grant(s)/PUSCH resource index(s) for this transmission are received by UE 702 in system information. PUSCH grant(s)/PUSCH resource index(s) for this transmission can be common for all UEs or these can be per group of UEs (per subgroup) wherein UE 702 selects from PUSCH grant(s)/PUSCH resource index(s) of its group (subgroup).

In one embodiment, the LP WUS is a PUCCH transmission. In case of beamforming, UE 702 selects gNB 704's best/suitable TX beam/SSB/LP SS and then selects a PUCCH resource corresponding to the selected TX beam/SSB/LP SS and transmits in the selected PUCCH resource. PUCCH resource(s)/PUCCH resource index(s) for this transmission are received by UE 702 in system information. PUCCH index(s) for this transmission are received by UE 702 in system information. PUCCH resource(s)/PUCCH resource index(s) for this transmission can be common for all UEs or these can be per group of UEs (per subgroup) wherein UE 702 selects from PUCCH resource(s)/PUCCH resource index(s) of its group (subgroup).

In one embodiment, the LP WUS is a reference signaling (e.g., SRS) transmission. In case of beamforming, UE 702 selects gNB 704's best/suitable TX beam/SSB/LP SS and then selects an SRS resource corresponding to the selected TX beam/SSB/LP SS and transmits in the selected SRS resource. SRS resource(s)/SRS resource index(s) for this transmission are received by UE 702 in system information. SRS resource(s)/SRS resource index(s) for this transmission can be common for all UEs or these can be per group of UEs (per subgroup) wherein UE 702 selects from SRS resource(s)/SRS resource index(s) of its group (subgroup).

If there is paging for one or more UEs at block 714 and gNB 704 has received (the reception may be in a pre-defined interval or period) the LP WUS from at least one UE in its cell, gNB transmits paging at block 718 and step 720. In one embodiment, if gNB 704 has received the LP WUS from at least one UE of (paging) subgroup for which there is paging (Note that gNB 704 can know about this based on mapping between a resource and (paging) subgroup and reception of the LP WUS in the resource mapped to the (paging) subgroup), gNB 704 transmits paging. In case of beamforming, gNB 704 transmits paging in the direction/coverage of TX beams(s)/SSB(s)/LP SS(s) indicated by each received LP WUS. The resource (PRACH/PUCCH/PUSCH/SRS) for the LP WUS from UE 702 is mapped to TX beams(s)/SSB(s)/LP SS(s) of gNB 704.

Based on a resource in which the LP WUS is received, gNB 704 can identify the TX beams(s)/SSB(s)/LP SS(s). In case gNB 704 has paging for one or more UEs in a cell and none of these UEs are there in the cell, gNB 704 will not receive the LP WUS and unnecessary paging transmission can be avoided. In case gNB 704 has paging for one or more UEs in a cell and these UEs are there in the cell in coverage of a subset of TX beams(s)/SSB(s)/LP SS(s), gNB will receive the LP WUS only for a subset of TX beams(s)/SSB(s)/LP SS(s), and unnecessary paging transmission on other TX beams(s)/SSB(s)/LP SS(s) can be avoided. For paging,
gNB 704 may transmit a PDCCH (addressed to P-RNTI) in a PO followed by a PDSCH (TB including paging message); or
gNB 704 may transmit a PDCCH (addressed to P-RNTI) in a PEI occasion, followed by a PDCCH (addressed to P-RNTI) in a PO followed by a PDSCH (TB including paging message).

At block 716, UE 702 monitors for paging as follows:
UE 702 may receive a PDCCH (addressed to P-RNTI) in a PO followed by a PDSCH (TB including paging message); or
UE 702 may receive a PDCCH (addressed to P-RNTI) in a PEI occasion, followed by a PDCCH (addressed to P-RNTI) in PO followed by PDSCH (TB including paging message).

Although FIG. 7 illustrates one example of a method 700 for on demand paging, various changes may be made to FIG. 7. For example, while shown as a series of steps, various steps in FIG. 7 could overlap, occur in parallel, occur in a different order, occur any number of times, be omitted, or replaced by other steps.

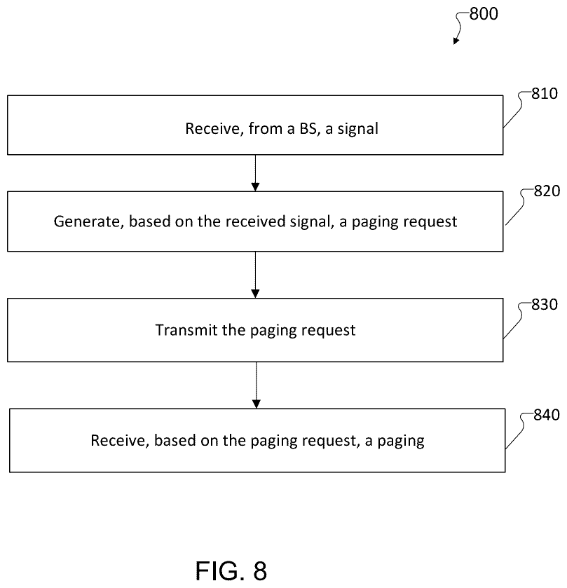

FIG. 8 illustrates another method 800 for on demand paging according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments for on demand paging could be used without departing from the scope of this disclosure.

In the example of FIG. 8, method 800 begins at step 810. At step 810, a UE, such as UE 116 of FIG. 1, receives from a BS, such a BS 102 of FIG. 1, a signal. The signal may be similar as described herein. At step 820, the UE generates, based on the signal, a paging request. At step 830, the UE transmits the paging request. Finally, at step 840, the UE receives, based on the paging request, a paging.

Although FIG. 8 illustrates one example of a method 700 for on demand paging, various changes may be made to FIG. 8. For example, while shown as a series of steps, various steps in FIG. 8 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive, from a base station (BS), a signal; and
a processor operably coupled to the transceiver, the processor configured to generate, based on the received signal, a paging request,
wherein the transceiver is further configured to:
transmit the paging request; and
receive, based on the paging request, a paging.

2. The UE of claim 1, wherein the signal is one of:
a low power wakeup signal (LP WUS); and
a paging early indication (PEI).

3. The UE of claim 1, wherein the signal includes at least one of:
information indicating a paging for the UE;
information indicating a paging for a paging subgroup of the UE;
information indicating to the UE to transmit the paging request; and
information indicating one or more resources for transmitting the paging request.

4. The UE of claim 3, wherein the paging request is transmitted based upon:
the signal including the information indicating the paging for the UE or the paging subgroup of the UE, and
the signal including at least one of:
the information indicating to the UE to transmit the paging request; and
the information indicating one or more resources for transmitting the paging request.

5. The UE of claim 1, wherein the transceiver is further configured to receive system information including:
an indication to transmit the paging request upon reception of the signal; or
information indicating one or more resources for transmitting the paging request.

6. The UE of claim 5, wherein the paging request is transmitted based upon:
the signal including information indicating a paging for the UE or a paging subgroup of the UE, and
the system information including at least one of:
the indication to transmit the paging request; or
the information indicating the one or more resources for transmitting the paging request.

7. The UE of claim 1, wherein:
the processor is further configured to select a resource from a plurality of resources,
the resource is selected based on:
a synchronization signal block (SSB); or
a lower power synchronization signal (LPSS), and
the transceiver is further configured to transmit the paging request in the selected resource.

8. A base station (BS) comprising:
a processor; and
a transceiver operably coupled to the processor, the transceiver configured to:
transmit a signal;
receive, from a user equipment (UE), a paging request; and
transmit, based on the paging request, a paging.

9. The BS of claim 8, wherein the signal is one of:
a low power wakeup signal (LP WUS); and
a paging early indication (PEI).

10. The BS of claim 8, wherein the signal includes at least one of:
information indicating a paging for the UE;
information indicating a paging for a paging subgroup of the UE;
information indicating to the UE to transmit the paging request; and
information indicating one or more resources for transmitting the paging request.

11. The BS of claim 10, wherein the paging request is received based upon:
the signal including the information indicating the paging for the UE or the paging subgroup of the UE, and
the signal including at least one of:
the information indicating to the UE to transmit the paging request; and
the information indicating one or more resources for transmitting the paging request.

12. The BS of claim 8, wherein the transceiver is further configured to transmit system information including:
an indication to transmit the paging request upon reception of the signal; or
information indicating one or more resources for transmitting the paging request.

13. The BS of claim 12, wherein the paging request is received based upon:
the signal including information indicating a paging for the UE or a paging subgroup of the UE, and
the system information including at least one of:
the indication to transmit the paging request; or
the information indicating the one or more resources for transmitting the paging request.

14. A method of operating a user equipment (UE), the method comprising:
receiving, from a base station (BS), a signal;
generating, based on the received signal, a paging request;
transmitting the paging request; and
receiving, based on the paging request, a paging.

15. The method of claim 14, wherein the signal is one of:
a low power wakeup signal (LP WUS); and
a paging early indication (PEI).

16. The method of claim 14, wherein the signal includes at least one of:
information indicating a paging for the UE;
information indicating a paging for a paging subgroup of the UE;
information indicating to the UE to transmit the paging request; and
information indicating one or more resources for transmitting the paging request.

17. The method of claim 16, wherein the paging request is transmitted based upon:
the signal including the information indicating the paging for the UE or the paging subgroup of the UE, and
the signal including at least one of:
the information indicating to the UE to transmit the paging request; and
the information indicating one or more resources for transmitting the paging request.

18. The method of claim 14, further comprising receiving system information including:
an indication to transmit the paging request upon reception of the signal; or
information indicating one or more resources for transmitting the paging request.

19. The method of claim 18, wherein the paging request is transmitted based upon:
the signal including information indicating a paging for the UE or a paging subgroup of the UE, and
the system information including at least one of:
the indication to transmit the paging request; or
the information indicating the one or more resources for transmitting the paging request.

20. The method of claim 14, further comprising:
selecting a resource from a plurality of resources; and
transmitting the paging request in the selected resource,
wherein the resource is selected based on:
a synchronization signal block (SSB); or
a lower power synchronization signal (LPSS).
